(19) United States
(12) Patent Application Publication
(10) Pub. No.: US 2025/0012327 A1
(43) Pub. Date: Jan. 9, 2025

(54) COMBINATION SEAL AND BEARING

(71) Applicant: Hanon Systems, Daejeon (KR)

(72) Inventor: Houssam Soubjaki, Detroit, MI (US)

(21) Appl. No.: 18/501,421

(22) Filed: Nov. 3, 2023

Related U.S. Application Data
(60) Provisional application No. 63/511,720, filed on Jul. 3, 2023.

(51) Int. Cl. F16C 33/74

(52) U.S. Cl. CPC F16C 33/74

(57) ABSTRACT

A combined seal and bearing member comprising a one-piece main body, a sealing element integrally formed with the main body, and a bearing surface integrally formed with the main body. The sealing element configured to abut a rotating component to facilitate a seal therebetween and the bearing surface configured to cooperate with the rotating component to facilitate relative rotational motion between the main body and the rotating component.

### CROSS-REFERENCE TO RELATED APPLICATION

This application claims the benefit of U.S. Provisional Patent Application Ser. No. 63/511,720, filed Jul. 3, 2023, the entirety of which is herein incorporated by reference.

### FIELD

The disclosure relates to seals and bearings for rotating components, and more particularly to a combined seal and bearing member for a rotating component.

### BACKGROUND

Rotors and shafts with bearings and seals are used in electric motors or actuators designed for automotive, industrial, commercial, or domestic applications. In such applications, it is known to use rotors, which rotate about a fixed shaft, or rotatable shafts and employ respective bearings and seals for this purpose. Oftentimes, the bearings used are sealed. Such sealed bearings typically include a bearing and a separate seal. Needle bearings, for instance, are configured to accept a pair of lip seals on one or both ends. This arrangement requires the parts to be procured separately and assembled together. Moreover, a bearing material is ideal for low friction, but not necessarily ideal to seal, and vice versa, a seal material is ideal for sealing, but not necessarily ideal as a bearing.

Prior art bearings and/or seals are shown in U.S. Pat. Nos. 9,638,327; 9,103,446, and U. S. Pat. Appl. Pub. No. 2006/0220286, the entire contents of each of which are hereby incorporated herein by reference. The '327 patent discloses a seal only. The '446 patent shows only a radial seal. The '286 published patent application includes an axial seal only.

Accordingly, it would be desirable to produce a combined seal and bearing member wherein a number of parts is minimized and sealing and bearing properties are maximized.

### SUMMARY

In concordance and agreement with the presently described subject matter, a combined seal and bearing member wherein a number of parts is minimized and sealing and bearing properties are maximized, has been designed.

In one embodiment, a combined seal and bearing member, comprises: a one-piece main body; a sealing element integrally formed with the main body; and a bearing surface integrally formed with the main body.

In another embodiment, an actuator, comprises: a rotating component; a stationary component disposed adjacent the rotating component; and a combined seal and bearing member disposed between the rotating component and the stationary component, the combined seal and bearing member, comprises: a one-piece main body; a sealing element integrally formed with the main body; and a bearing surface integrally formed with the main body.

In yet another embodiment, a method of controlling wear between components, comprises: providing a rotating component; providing a stationary component disposed adjacent the rotating component; and disposing a combined seal and bearing member between the rotating component and the stationary component, the combined seal and bearing member, comprises: a one-piece main body; a sealing element integrally formed with the main body; and a bearing surface integrally formed with the main body.

As aspects of some embodiments, the main body, the sealing element, and the bearing surface are formed from a polytetrafluoroethylene (PTFE) material.

As aspects of some embodiments, the member is formed by an injection molding process.

As aspects of some embodiments, the sealing element is a radial seal.

As aspects of some embodiments, the main body includes a central aperture formed therethrough to receive at least a portion of a rotating component therein.

As aspects of some embodiments, the sealing element and the bearing surface are integrally formed on an inner surface of the main body defining the central aperture.

As aspects of some embodiments, a cross-sectional shape of the main body is generally h-shaped.

As aspects of some embodiments, an outer wall of the main body includes a shoulder formed therein.

As aspects of some embodiments, the bearing surface comprises a generally cylindrical section of the main body.

As aspects of some embodiments, the main body includes a flexible projection.

As aspects of some embodiments, the sealing element is integrally formed with the flexible projection.

As aspects of some embodiments, the sealing element is formed at a free end of the flexible projection.

As aspects of some embodiments, the flexible projection is configured to cause a radial inward force to be applied against the rotating component to facilitate a seal between the rotating component and the member.

As aspects of some embodiments, a space is formed between the flexible projection and a shoulder portion of the main body.

As aspects of some embodiments, an outer surface of the main body is configured to cooperate with a stationary component.

As aspects of some embodiments, an edge region of the main body is tapered to facilitate installation of the member on the rotating component.

As aspects of some embodiments, the main body is configured to be at least partially received between a rotating component and a stationary component.

As aspects of some embodiments, the main body has a generally annular shape.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a combined seal and bearing member;

FIG. 2 is a bottom perspective view of the member of FIG. 1;

FIG. 3 is a top plan view of the member of FIGS. 1 and 2;

FIG. 4 is a bottom plan view of the member of FIGS. 1-3;

FIG. 5 is a cross-sectional view of the member of FIGS. 1-4;

FIG. 6 is an elevational section view of the combined seal and bearing member of FIGS. 1-5 in use with a rotating component.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

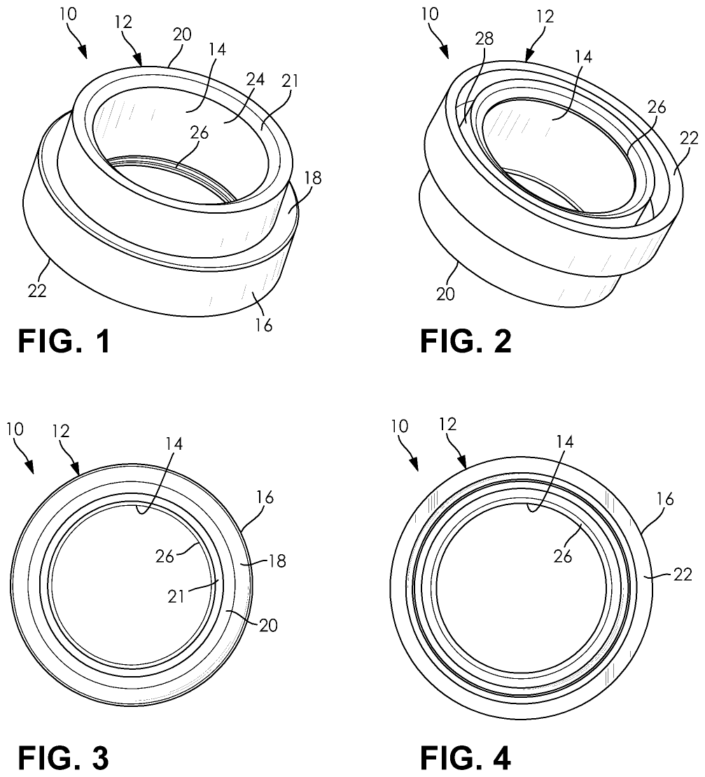

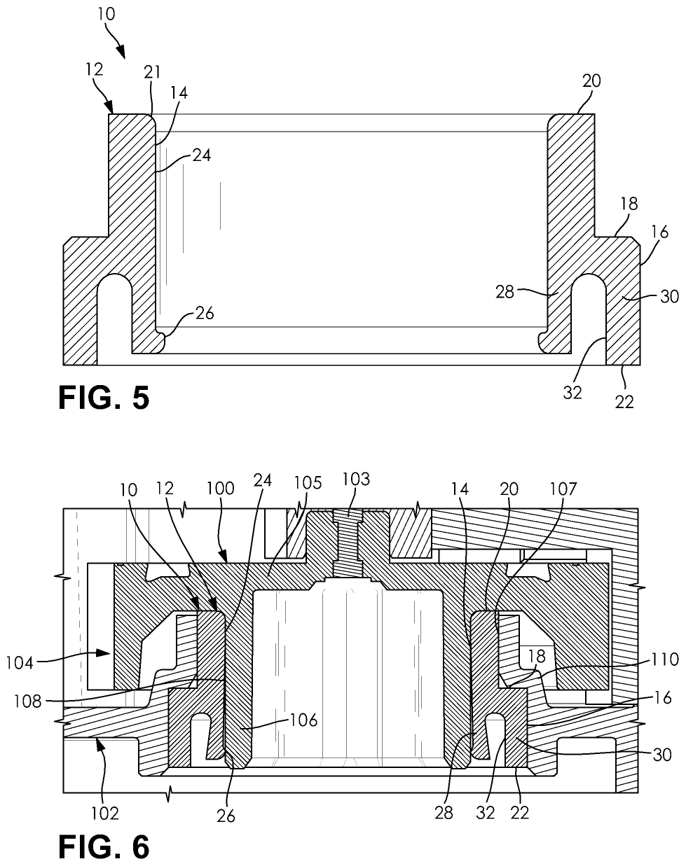

FIG. 1-5 show a combined seal and bearing member 10 according an exemplary embodiment of the present disclosure. The combined seal and bearing member 10 may be configured for use with various rotating components, for example, a rotor or a rotating shaft. Further, it is understood the combined seal and bearing member 10 may be used with other components and structures without departing from the scope of the present disclosure. As shown, the combined seal and bearing member 10 includes a unitary, annular main body 12 having a central aperture 14 formed therein. The aperture 14 extends axially through an entirety of the main body 12. In some embodiments, the aperture 14 may be configured to receive at least a portion of a rotating component 100 (shown in FIG. 6) therein. In certain instances, the rotating component 100 extends entirely through the aperture 14, although it is understood that other arrangements may be used as desired.

As shown, the main body 12 may be formed as a single piece structure from a single material. The material may be any material having desirable properties as a bearing component and a sealing component. In preferred embodiments, the main body 12 is formed from a polytetrafluoroethylene (PTFE) material. The PTFE material is advantageous because it has an extremely low coefficient of friction while also being sufficiently compliant, flexible, and resilient to perform as a seal without wear and damage. Various other materials that exhibit substantially the same or similar properties may be employed for the combined seal and bearing member 10 if desired.

In some embodiments, the main body 12 may be formed by injection molding, although other forming methods may be used as desired such as other subtractive manufacturing or additive manufacturing (e.g., 3-D printing), for example.

An outer wall 16 of the combined seal and bearing member 10 may be configured to be received in a stationary component (e.g., a housing, a stator, and the like) or other member to fixedly retain the combined seal and bearing member 10 therein. However, it is understood the combined seal and bearing member 10 may be received in a rotating component and receive at least a portion of a stationary component in the aperture 14 formed therein without departing from the scope of the present disclosure. In some embodiments, the combined seal and bearing member 10 may be generally h-shaped with the outer wall 16 of the combined seal and bearing member 10 including a step or shoulder 18 formed therein. The shoulder 18 may assist in militating against relative movement between the stationary component and the combined seal and bearing member 10. As shown, the shoulder 18 may be formed intermediate a first end 20 and a second end 22 of the combined seal and bearing member 10.

At least a portion of an inner surface of the main body 12 forming the aperture 14 may be configured as a bearing surface 24 configured to receive the rotating component 100. The bearing surface 24 may be formed as a right circular cylinder surface or other configuration as desired. The inner surface may further be formed as a substantially continuous surface, although it is understood the inner surface can be formed as a linear array of inner surfaces separated by channels (not depicted) formed to surround the aperture 14. The channels may be configured to hold and supply a lubricant, for example. Other configurations can be used as desired. Further, the inner surface may typically be formed from a substantially smooth surface to facilitate relative rotation between the inner surface and the rotating component 100, although it is understood that other bearing surfaces 24 may be used as desired, such as a corrugated or other irregular surface configured as the bearing surface 24.

The first end 20 of the main body 12 of the combined seal and bearing member 10 may be configured to abut a portion of the rotating component 100, or the stationary component, or may be free floating as desired. In certain embodiments, an edge region 21 of the first end 20 may be tapered to facilitate installation of the combined seal and bearing member 10 onto and/or around the rotating component 100. The second end 22 of the main body 12 of the combined seal and bearing member 10 may include an annular sealing element 26 (e.g., a lip) as shown. The sealing element 26 may be configured to abut the rotating component 100 to provide a seal between the main body 12 and the rotating component 100. It is understood the sealing element 26 may be located elsewhere on the main body 12 such as an intermediate location within the aperture 14 or on the outer wall 16 of the main body 12 if sealing a surrounding component is desired. The sealing element 26 can have any shape, size, and configuration as desired which results in desired sealing properties between the rotating component 100 and the main body 12. For example, the sealing element 26 may have a triangular, rectangular, ovular, irregular, or other cross-sectional shapes, as desired. Favorable results have been obtained wherein the sealing element 26 has a generally circular or rounded cross-sectional shape. Further as shown, the sealing element 26 may be formed adjacent the second end 22 of the main body 12 at a free end of a flexible and/or resilient projection 28 (e.g., a tab, an arm, or the like). The projection 28 may be formed radially inwardly and spaced from a shoulder portion 30 of the outer wall 16 of the main body 12. An annular space 32 may be formed between the projection 28 and the shoulder portion 30. The space 32 allows for and facilitates a radial outer movement and/or flexing of at least a portion of the projection 28 when the combined seal and bearing member 10 is installed on the rotating component 100. Thus, the flexible and/or resilient properties of the projection 28 cause a radial inward force to be applied against the rotating component 100 to facilitate a desired seal between the rotating component 100 and the combined seal and bearing member 10.

Shortcomings of the prior art is that the seals and/or bearings are expensive and require assembly. As such, the combined seal and bearing member 10, and preferably an injection molded combined seal and bearing member 10, including the bearing surface 24 with the integrated seal element 26 on the flexible projection 28 provides continuous pressure on the rotating component 100 such as the rotor or shaft or various other components that require sealing. The instant design involves integration of the bearing surface 24 with the sealing element 26 molded as a unitary part of the same material. The sealing element 26 ensures physical contact to the rotating component 100 intended to be sealed via the projection 28 that is also molded as part of the unitary main body 12. The combined seal and bearing member 10 also provides for a plain cylindrical bearing surface 24. The integrated seal element 26 has the compliance to not hinder the bearing surface 24 while providing adequate contact at all times. Thus, critical features of the combined seal and bearing member 10 include a design of the specific geometry of the sealing element 26 along with the projection 28.

The combined seal and bearing member 10 is an improvement over prior art bearings and seals because the combined seal and bearing member 10 of the present disclosure incorporates the geometry of a lip seal (line contact) as part of the bearing using the same material of construction and produced from the same process, thereby maximizing efficiency and minimizing cost by reducing a number of parts, service, and logistics, for example.

FIG. 6 depicts an exemplary embodiment of an actuator 104 according to the present disclosure. The actuator 104 may include the combined seal and bearing member 10 disposed between the rotating component 100 and a stationary component 102. In some embodiments, the rotating component 100 may be a rotor or a shaft of the actuator 104. The rotating component 100 may include a main body 105 having a hub 106 extending axially outwardly therefrom. In some embodiments, a space 107 may be formed between the rotating component 100 and the stationary component 102. The space 107 may be configured to receive the combined seal and bearing member 10 at least partially therein. As illustrated, the hub 106 of the rotating component 100 may be received into the aperture 14 of the main body 12 so that the bearing surface 24 and the sealing element 26 each abut an outer surface 108 of the hub 106 of the rotating component 100. When installed, the sealing element 26 is urged against the outer surface 108 of the hub 106 to form a seal therebetween. It can be seen that the stationary component 102 may include a shoulder portion 110 configured to cooperate with the shoulder 18 and shoulder portion 30 of the combined seal and bearing member 10.

In accordance with exemplary embodiments of the present disclosure shown in FIG. 6, the rotating component 100 may be part of the actuator 104 employed in various system applications, for example, a fluid valve system (not depicted). In certain applications, the actuator 104 may be configured to selectively control and/or actuate other components of the system.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A combined seal and bearing member, comprising:
a one-piece main body;
a sealing element integrally formed with the main body; and
a bearing surface integrally formed with the main body.

2. The member of claim 1, wherein the main body, the sealing element, and the bearing surface are formed from a polytetrafluoroethylene (PTFE) material.

3. The member of claim 1, wherein the member is formed by an injection molding process.

4. The member of claim 1, wherein the sealing element is a radial seal.

5. The member of claim 1, wherein the main body includes a central aperture formed therethrough to receive at least a portion of a rotating component therein.

6. The member of claim 5, wherein the sealing element and the bearing surface are integrally formed on an inner surface of the main body defining the central aperture.

7. The member of claim 1, wherein a cross-sectional shape of the main body is generally h-shaped.

8. The member of claim 1, wherein an outer wall of the main body includes a shoulder formed therein.

9. The member of claim 1, wherein the bearing surface comprises a generally cylindrical section of the main body.

10. The member of claim 1, wherein the main body includes a flexible projection.

11. The member of claim 10, wherein the sealing element is integrally formed with the flexible projection.

12. The member of claim 10, wherein the sealing element is formed at a free end of the flexible projection.

13. The member of claim 10, wherein the flexible projection is configured to cause a radial inward force to be applied against the rotating component to facilitate a seal between the rotating component and the member.

14. The member of claim 10, wherein a space is formed between the flexible projection and a shoulder portion of the main body.

15. The member of claim 1, wherein an outer surface of the main body is configured to cooperate with a stationary component.

16. The member of claim 1, wherein an edge region of the main body is tapered to facilitate installation of the member on the rotating component.

17. The member of claim 1, wherein the main body is configured to be at least partially received between a rotating component and a stationary component.

18. The member of claim 1, wherein the main body has a generally annular shape.

19. An actuator, comprising:
a rotating component;
a stationary component disposed adjacent the rotating component; and
a combined seal and bearing member disposed between the rotating component and the stationary component, the combined seal and bearing member, comprising:
a one-piece main body;
a sealing element integrally formed with the main body; and
a bearing surface integrally formed with the main body.

20. A method of controlling wear between components, comprising:
providing a rotating component;
providing a stationary component disposed adjacent the rotating component; and
disposing a combined seal and bearing member between the rotating component and the stationary component, the combined seal and bearing member, comprising:
a one-piece main body;
a sealing element integrally formed with the main body; and
a bearing surface integrally formed with the main body.
